(19) United States
(12) Patent Application Publication
(10) Pub. No.: US 2021/0140515 A1
(43) Pub. Date: May 13, 2021

(54) SPEED REDUCING UNIT

(71) Applicant: TOYOTA JIDOSHA KABUSHIKI KAISHA, Aichi (JP)

(72) Inventor: Hiroshi ISONO, Mishima-shi (JP)

(21) Appl. No.: 17/094,810

(22) Filed: Nov. 11, 2020

(30) Foreign Application Priority Data
Nov. 12, 2019 (JP) 2019-204570

(51) Int. Cl. F16H 1/28; B60K 17/04; B60K 17/08; B60K 5/00; B60K 1/00; B60L 7/10

(52) U.S. Cl. CPC F16H 1/28; B60K 17/046; B60K 17/08; F16H 2001/2881; B60K 1/00; B60L 7/10; B60K 5/00

(57) ABSTRACT

A speed reducing unit having a simple structure that can establish a large speed reduction ratio. The speed reducing unit comprises a geared transmission mechanism and a fixed member. An input member, an output member, and the geared transmission mechanism are supported by the fixed member. The geared transmission mechanism comprises: a first ring gear fixed to the fixed member; a second ring gear rotated integrally with the output member; a first pinion meshing with the first ring gear; a second pinion meshing with the second ring gear; and a carrier supporting the first pinion and the second pinion that is rotated integrally with the input member. A gear ratio between the first ring gear and the first pinion and a gear ratio between the second ring gear and the second pinion are set to different values.

### CROSS REFERENCE TO RELATED APPLICATION

The present disclosure claims the benefit of Japanese Patent Application No. 2019-204570 filed on Nov. 12, 2019, with the Japanese Patent Office, the disclosures of which are incorporated herein by reference in its entirety.

### BACKGROUND

### Field of the Disclosure

Embodiments of the present disclosure relate to the art of a speed reducing unit that serves as a hub mechanism or a hub bearing connecting drive wheels to a chassis, and that transmits an output torque of an actuator to the drive wheels while multiplying.

### Discussion of the Related Art

JP-A-2005-308111 describes a drive unit for a motor-driven vehicle serving as a hub reduction gear unit that transmits a drive torque to driving wheels while reducing a speed of an output shaft of a prime mover. According to the teachings of JP-A-2005-308111, a single-pinion planetary gear unit is adopted as the hub reduction gear unit. Specifically, the hub reduction gear unit taught by JP-A-2005-308111 comprises: a sun gear formed on the output shaft of the prime mover; a ring gear as an internal gear that is not allowed to rotate; a plurality of pinion gears interposed between the sun gear and the ring gear; and a carrier that is joined to the driving wheels while supporting the pinion gears in a rotatable manner. That is, the sun gear serves as an input element, the carrier serves as an output element, and the ring gear serves as a reaction element. In the hub reduction gear unit taught by JP-A-2005-308111, therefore, a rotational speed of the carrier is reduced slower than a rotational speed of the sun gear. In other words, the output torque of the prime mover is transmitted to the driving wheels through the reduction gear unit while being multiplied.

JP-A-2019-60480 describes a hub reduction gear unit formed by combining two sets of planetary gear unit. The hub reduction gear unit taught by JP-A-2019-60480 comprises: a first sun gear formed on an axle; a short pinion engaged with the first sun gear; a long pinion engaged with the short pinion; a second sun gear arranged coaxially with the first sun gear while being engaged with the long pinion to apply a reaction force to the long pinion; and a carrier supporting the short pinion and the long pinion. The carrier is joined to a drive wheel to serve as a wheel hub.

As described, the hub reduction gear unit taught by JP-A-2005-308111 is formed of one set of the planetary gear unit. That is, a speed reduction ratio of the hub reduction gear unit taught by JP-A-2005-308111 is governed by a gear ratio of the planetary gear unit. On the other hand, since the hub reduction gear unit taught by JP-A-2019-60480 is formed of a plurality of the planetary gear unit, a speed reduction ratio of the hub reduction gear unit taught by JP-A-2019-60480 is greater than that of the hub reduction gear unit taught by JP-A-2005-308111. For example, according to the example shown in FIG. 2 of JP-A-2019-60480, a rotational speed of the second sun gear serving as a reaction element is reduced slower than a rotational speed of the axle by the second planetary gear unit so that a torque transmitted through the hub reduction gear unit is further multiplied.

However, in the hub reduction gear unit taught by JP-A-2019-60480, the long pinion is arranged radially outer side of the short pinion meshing with the sun gear of the complex planetary gear unit. For this reason, although a ring gear is not employed in the hub reduction gear unit taught by JP-A-2019-60480, a size of the hub reduction gear unit has to be enlarged in a radial direction. In addition, a structure of the complex planetary gear unit is rather complicated, and large number of parts are required to form the complex planetary gear unit. For example, two sets of the short pinions and two sets of the long pinions are arranged in the complex planetary gear unit shown in FIG. 2 of JP-A-2019-60480. That is, at least twenty gears including four sun gears, eight short pinions, and eight long pinions are required to form the complex planetary gear unit shown in FIG. 2 of JP-A-2019-60480.

Thus, it is required to downsize the conventional hub reduction gear units using the complex planetary gear unit while ensuring a large speed reduction ratio.

### SUMMARY

Aspects of embodiments of the present disclosure have been conceived noting the foregoing technical problems, and it is therefore an object of embodiments of the present disclosure to provide a speed reducing unit having a simple structure that can establish a large speed reduction ratio.

An exemplary embodiment of the present disclosure relates to a speed reducing unit that transmits a torque between an input member and an output member while multiplying the torque, comprising: a geared transmission mechanism that transmits a torque between the input member and the output member; and a fixed member that supports the input member, the output member, and the geared transmission mechanism in a rotatable manner, and that fixes a fixed element of the geared transmission mechanism. The geared transmission mechanism comprises: a first ring gear as an internal gear that is fixed to the fixed member; a second ring gear as an internal gear that is attached to the output member coaxially with the first ring gear to be rotated integrally with the output member; a first pinion meshing with the first ring gear; a second pinion that is arranged coaxially with the first pinion to be rotated integrally with the first pinion while meshing with the second ring gear; a pinion shaft that supports the first pinion and the second pinion in a rotatable manner; and a carrier that supports the first pinion and the second pinion in a rotatable manner through the pinion shaft, and that is mounted on the input member to be rotated integrally with the input member. In order to achieve the above-explained objective, according to the exemplary embodiment of the present disclosure, a gear ratio between the first ring gear and the first pinion and a gear ratio between the second ring gear and the second pinion are set to different values such that a rotational speed of the output member is reduced lower than a rotational speed of the input member.

In a non-limiting embodiment, number of teeth of the first ring gear and number of teeth of the second ring gear may be set to different numbers, and number of teeth of the first pinion and number of teeth of the second pinion may be set to the same number.

In a non-limiting embodiment, number of teeth of the first ring gear and number of teeth of the second ring gear may be set to the same number, and number of teeth of the first pinion and number of teeth of the second pinion may be set to different numbers.

In a non-limiting embodiment, number of teeth of the first ring gear and number of teeth of the second ring gear may be set to different numbers, and number of teeth of the first pinion and number of teeth of the second pinion may be set to different numbers.

In a non-limiting embodiment, the input member may include an input shaft to which an output torque of an actuator of a vehicle is applied, the output member may include an output hub that is attached to a wheel of the vehicle to be rotated integrally with the wheel, and the fixed member may include a fixed hub that is fixed to a chassis of the vehicle or a housing of the actuator. Therefore, the speed reducing unit may serves as a hub mechanism that connects the wheel to the chassis.

In a non-limiting embodiment, the fixed hub may be connected to the chassis, and the actuator may be disposed on the chassis to deliver the output torque to the input shaft through a driveshaft.

In a non-limiting embodiment, the fixed hub may be fixed to the housing while being connected to the chassis together with the actuator, and the actuator may be held in an inner circumferential space of the wheel to apply the output torque directly to the input shaft.

In a non-limiting embodiment, the actuator may include at least any one of: an engine that generates a drive torque; an electric motor that generates a drive torque and a regenerative torque; and a brake device that generates a brake torque.

Thus, in the geared transmission mechanism of the speed reducing unit according to the exemplary embodiment of the present disclosure, the first pinion and the second pinion are supported by the carrier to revolve around the input member along the first ring gear and the second ring gear. The first ring gear as the fixed element is fixed to the fixed member to apply a reaction force to the first pinion, and the first pinion and the second pinion are rotated integrally on the pinion shaft. The carrier supporting the first pinion and the second pinion is rotated integrally with the input member so that the second ring gear meshing with the second pinion is rotated together with the output member. According to the exemplary embodiment of the present disclosure, the gear ratio between the first ring gear and the first pinion, and the gear ratio between the second ring gear and the second pinion are set to different values. To this end, number of teeth of the first ring gear and number of teeth of the second ring gear are set to different numbers, or number of teeth of the first pinion and number of teeth of the second pinion are set to different numbers. Otherwise, number of teeth of the first ring gear and number of teeth of the second ring gear are set to different numbers, and number of teeth of the first pinion and number of teeth of the of the second pinion are set to different numbers. That is, the gear ratio between the first ring gear and the first pinion, and the gear ratio between the second ring gear and the second pinion may be set to different values by adjusting the numbers of teeth of the gears.

Given that the gear ratio between the first ring gear and the first pinion, and the gear ratio between the second ring gear and the second pinion are set to the same value, a speed reduction ratio of the geared transmission mechanism reaches an infinite value. In this case, since the first ring gear is the fixed element, the second ring gear integrated with the output member is not allowed to rotate. In order to avoid such disadvantage, according to the exemplary embodiment of the present disclosure, the gear ratio between the first ring gear and the first pinion and the gear ratio between the second ring gear and the second pinion are set to different values. According to the exemplary embodiment of the present disclosure, therefore, the speed reduction ratio of the geared transmission mechanism can be increased without reaching the infinite value. In other words, the speed reduction ratio of the geared transmission mechanism is reduced with an increase in the difference between the above-mentioned gear ratios. That is, the speed reduction ratio of the geared transmission mechanism can be increased by reducing the difference between the above-mentioned gear ratios.

In addition, a sun gear is not arranged around the input member in the geared transmission mechanism as a complex planetary gear unit. According to the exemplary embodiment of the present disclosure, therefore, the speed reducing unit having the geared transmission mechanism can be downsized. Further, number of gears in the speed reducing unit can be reduced.

The speed reducing unit according to the exemplary embodiment of the present disclosure may be applied to a vehicle to serve as a hub mechanism. In this case, the input member is connected to an output shaft of an actuator of the vehicle to serve as an input shaft, the output member is fixed to e.g., a wheel of the vehicle to serve as an output hub, and the fixed member is fixed to a chassis or a housing of the actuator to serves as a fixed hub.

In a case of using the speed reducing unit according to the exemplary embodiment of the present disclosure as a hub mechanism in an on-board power unit, the speed reducing unit is connected to the chassis through e.g., a suspension mechanism, and the output shaft of the actuator disposed on the chassis is connected to the wheel through the input shaft of the speed reducing unit. In this case, since the speed reducing unit is diametrically downsized, the speed reducing unit may be fitted easily into an inner circumferential space of the wheel. In addition, since the speed reduction ratio of the geared transmission mechanism is increased, the torque of the actuator can be multiplied sufficiently. For this reason, the actuator serving as a prime mover may also be downsized. As a result, a weight of the vehicle may be trimmed, and a greater design freedom within the chassis may be ensured.

In a case of using the speed reducing unit according to the exemplary embodiment of the present disclosure as a hub mechanism in an in-wheel power unit, the speed reducing unit is integrated with the actuator and connected to the chassis through e.g., a suspension mechanism. As described, since the speed reducing unit is diametrically downsized, the speed reducing unit may be fitted easily into the inner circumferential space of the wheel. In addition, since the speed reduction ratio of the geared transmission mechanism is increased, the torque of the actuator can be multiplied sufficiently. For this reason, the actuator may also be downsized. That is, a greater design freedom in the wheel may be ensured, and hence the electric motor, the brake device or the like may be arranged easily in the wheel.

Thus, the speed reducing unit according to the exemplary embodiment of the present disclosure may be applied to the on-board power unit and the in-wheel power unit. In the case of arranging the speed reducing unit in the wheel together with the downsized electric motor, an unsprung weight of the vehicle can be reduced. Especially, in the case of employing the electric motor and the brake device as the actuator, the regenerative torque and the brake torque are delivered to a same point of a tire thorough the speed reducing unit. In this case, therefore, behavior of the vehicle can be stabilized when stopping the vehicle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a cross-sectional view showing a structure of the speed reducing unit according to the first example of the present disclosure;

FIG. 2 is a cross-sectional view showing the second example of the present disclosure in which the speed reducing unit is applied to an on-board power unit; and

FIG. 3 is a cross-sectional view showing the third example of the present disclosure in which the speed reducing unit is applied to an in-wheel power unit.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure which should not limit a scope of the present disclosure.

Referring now to FIG. 1, there is shown a structure of a speed reducing unit 1 according to the first example of the present disclosure. As shown in FIG. 1, the speed reducing unit 1 comprises an input member 2, an output member 3, a fixed member 4, and a geared transmission mechanism 5.

The input member 2 is a rotary member such as a hub and a shaft. According to the first example, a solid shaft member is adopted as the input member 2, and an output shaft of an external actuator (neither of which are shown) is joined to the input member 2 so that a torque of the actuator is applied to the input member 2. For example, a drive torque or a regenerative torque of a motor (not shown), or a brake torque of a brake device (not shown) is applied to one end (i.e., the right end in FIG. 1) of the input member 2 protruding from the speed reducing unit 1. Otherwise, a drive torque of an internal combustion engine (not shown) may also be applied to the end portion of the input member 2 protruding from the speed reducing unit 1. Specifically, the input member 2 is supported by the fixed member 4 through bearings 7 and 11 so that the input member 2 is allowed to rotate relatively not only to the output member 3 but also to the fixed member 4.

The output member 3 is also a rotary member such as a hub and a shaft. According to the first example, a hollow shaft member is adopted as the output member 3, and an external member such as a wheel or a rotary shaft (neither of which are shown) is joined to the output member 3 so that the torque is transmitted from the output member 3 to the external member. Specifically, a flange 3a is formed around one end (i.e., the left end in FIG. 1) of the output member 3, and a through hole 3b to which a bolt 6 is inserted is formed on the flange 3a. A hollow shaft portion 3c extends from the flange 3a toward the fixed member 4 (i.e., toward the right side in FIG. 1) while being supported by bearings 9 and 10, and the fixed member 4 and the geared transmission mechanism 5 are held in the hollow shaft portion 3c. Thus, the hollow shaft portion 3c serves as a casing or housing of the speed reducing unit 1. The above-mentioned bearing 7 is fitted into a center hole of the flange 3a of the output member 3, and the input member 2 is supported by the bearing 7 in a rotatable manner so that the output member 3 is allowed to rotate relatively not only to the input member 2 but also to the fixed member 4.

Thus, the input member 2 and the output member 3 are supported by the fixed member 4 in a rotatable manner. In addition, rotary elements of the geared transmission mechanism 5 including a second ring gear 13 and a carrier 17 are also supported by the fixed member 4 in a rotatable manner, and a first ring gear 12 as a fixed element of the geared transmission mechanism 5 is fixed by the fixed member 4. Specifically, the fixed member 4 is a hollow hub member connected to e.g., a suspension or a motor housing (neither of which are shown). A flange 4a is formed around one end (i.e., the right end in FIG. 1) of the fixed member 4, and a through hole 4b to which a bolt 8 is inserted is formed on the flange 4a. A hollow shaft portion 4c extends from the flange 4a toward the output member 3 (i.e., toward the left side in FIG. 1), and a part of the geared transmission mechanism 5 is held in the hollow shaft portion 4c. That is, the above-mentioned bearings 9 and 11 are interposed between the hollow shaft portion 3c of the output member 3 and the hollow shaft portion 4c of the fixed member 4. The above-mentioned bearing 11 is fitted into a center hole of the flange 4a of the fixed member 4, and the input member 2 is supported by the bearing 11 in a rotatable manner.

The geared transmission mechanism 5 comprises a first ring gear 12, a second ring gear 13, a first pinions 14, a second pinions 15, a pinion shafts 16, and a carrier 17. That is, the geared transmission mechanism 5 serves as a complex planetary gear unit.

The first ring gear 12 as an internal gear is fixed to an inner circumferential surface of the hollow shaft portion 4c of the fixed member 4, and hence the first ring gear 12 is not allowed to rotate. Instead, the first ring gear 12 may also be formed integrally with the hollow shaft portion 4c of the fixed member 4. Thus, a rotation of the first ring gear 12 is restricted by the fixed member 4 so that the first ring gear 12 serves as a fixed element of the geared transmission mechanism 5.

The second ring gear 13 is also an internal gear, and is arranged coaxially with the first ring gear 12 along a rotational center axis AL. Specifically, the second ring gear 13 is attached to an inner circumferential surface of the hollow shaft portion 3c of the output member 3 so that the second ring gear 13 is rotated integrally with the output member 3. Instead, the second ring gear 13 may also be formed integrally with the hollow shaft portion 3c of the output member 3. That is, the second ring gear 13 is also supported by the fixed member 4 together with the output member 3 while being allowed to rotate relatively to the fixed member 4.

Each of the first pinion 14 and the second pinion 15 is a diametrically small external gear. The first pinion 14 is meshed with the first ring gear 12, and the second pinion 15 is meshed with the second ring gear 13. Specifically, the first pinion 14 is mounted on one end (i.e., the right end in FIG. 1) of the pinion shaft 16 to rotate integrally therewith, and the second pinion 15 is mounted on the other end (i.e., the left end in FIG. 1) of the pinion shaft 16 to rotate integrally therewith. That is, the first pinion 14, the second pinion 15, and the pinion shaft 16 are arranged coaxially to one another, and a set of the first pinion 14, the second pinion 15, and the pinion shaft 16 is rotated integrally.

The set of the first pinion 14, the second pinion 15, and the pinion shaft 16 is supported by the carrier 17 while being allowed to rotate. Specifically, the carrier 17 comprises a first arm 17a that supports one end of the pinion shaft 16 in a rotatable manner, and a second arm 17b that supports the other end of the pinion shaft 16 in a rotatable manner. The first arm 17a and the second arm 17b of the carrier 17 are fixedly mounted on the input member 2 to rotate integrally with the input member 2 so that the carrier 17 serves as a rotary element of the geared transmission mechanism 5. When the carrier 17 is rotated together with the input member 2, the first pinion 14 revolves around the input member 2 along the internal teeth of the first ring gear 12, and the second pinion 15 revolves around the input member 2 along the internal teeth of the second ring gear 13.

Thus, the first pinion 14 and the second pinion 15 are supported by the carrier 17 while being allowed to rotate and revolve around the input member 2. Therefore, although the geared transmission mechanism 5 does not have a sun gear, the geared transmission mechanism 5 is allowed to serve as a complex planetary gear unit in which the first pinion 14 and the second pinion 15 serve as planetary gears.

The geared transmission mechanism 5 comprises at least one set of the of the first pinion 14, the second pinion 15, and the pinion shaft 16. In FIG. 1, two sets of the of the first pinion 14, the second pinion 15, and the pinion shaft 16 are illustrated. However, it is preferable to arrange at least three sets of the of the first pinion 14, the second pinion 15, and the pinion shaft 16 in the geared transmission mechanism 5 around the input member 2 at regular intervals.

As described, the speed reducing unit 1 is adapted to establish a large speed reduction ratio with a simple and downsized structure. To this end, a first gear ratio u₁ between the first ring gear 12 and the first pinion 14 and a second gear ratio u₂ between the second ring gear 13 and the second pinion 15 are set to different ratios such that a rotational speed of the output member 3 is reduced lower than a rotational speed of the input member 2. According to the exemplary embodiment of the present disclosure, definition of the “speed reduction ratio” is a ratio of a rotational speed of the output member 3 to a rotational speed of the input member 2.

Specifically, number of teeth of the first ring gear 12 and number of teeth of the second ring gear 13 are set to different numbers, and number of teeth of the first pinion 14 and number of teeth of the of the second pinion 15 are set to the same number. Otherwise, the first gear ratio u₁ and the second gear ratio u₂ may also be set to different values by setting the number of teeth of the first ring gear 12 and the number of teeth of the second ring gear 13 to the same number, and setting the number of teeth of the first pinion 14 and the number of teeth of the of the second pinion 15 to different numbers. Instead, the first gear ratio u₁ and the second gear ratio u₂ may also be set to different values by setting the number of teeth of the first ring gear 12 and the number of teeth of the second ring gear 13 to different numbers, and setting the number of teeth of the first pinion 14 and the number of teeth of the of the second pinion 15 to different numbers. Thus, the first gear ratio u₁ and the second gear ratio u₂ may be set to different values easily by adjusting the numbers of teeth of the first ring gear 12, the second ring gear 13 the first pinion 14, and the second pinion 15.

In the following description, the first gear ratio u₁ will also be referred to as the first gear ratio u₁ of the fixed element, and the second gear ratio u₂ will also be referred to as the second gear ratio u₂ of the output element.

Specifically, given that the number of teeth of the first pinion 14 is z_{P1} and the number of teeth of the first ring gear 12 is z_{R1}, the first gear ratio u₁ between the first ring gear 12 and the first pinion 14 may be expressed as:

u₁=z_{P1}/z_{R1}.

Likewise, given that the number of teeth of the second pinion 15 is z_{P2} and the number of teeth of the second ring gear 13 is z_{R2}, the first gear ratio u₂ between the second ring gear 13 and the second pinion 15 may be expressed as:

u₂=z_{P2}/z_{R2}.

Specifically, according to the first example shown in FIG. 1, the number of teeth of the first ring gear 12 is set to 45, the number of teeth of the second ring gear 13 is set to 50, the number of teeth of the first pinion 14 is set to 17, and the number of teeth of the second pinion 15 is also set to 17. Accordingly, the first gear ratio u₁ may be expressed as:

u₁=17/45≈0.38.

On the other hand, the second gear ratio u₂ may be expressed as:

u₁=17/50=0.34.

Given that the number of teeth of the first ring gear 12 is z_{R1}, the number of teeth of the second ring gear 13 is z_{R2}, the number of teeth of the first pinion 14 is z_{P1}, and the number of teeth of the second pinion 15 is z_{P2}, a speed reduction ratio R of the geared transmission mechanism 5 may be theoretically calculated using the following formula:

R=1/{1−(z_{R1}/z_{P1})·(z_{P2}/z_{R2})}.

As described, according to the first example shown in FIG. 1, the number of teeth z_{R1} of the first ring gear 12 is 45, the number of teeth z_{R2} of the second ring gear 13 is 50, the number of teeth z_{P1} of the first pinion 14 is 17, and the number of teeth z_{P2} of the second pinion 15 is 17. Accordingly, the speed reduction ratio R of the geared transmission mechanism 5 may be expressed as:

R=1/{1−(45/17)·(17/50)}=10.

For example, given that the number of teeth z_{R1} of the first ring gear 12 is 48, the number of teeth z_{R2} of the second ring gear 13 is 50, the number of teeth z_{P1} of the first pinion 14 is 17, and the number of teeth z_{P2} of the second pinion 15 is 17, the speed reduction ratio R of the geared transmission mechanism 5 is increased to 25 as expressed by the following expression:

R=1/{1−(48/17)·(17/50)}=25.

In general, a speed reduction ratio achieved by the conventional planetary gear sets falls within a range of approximately 4 to 10. Thus, the speed reduction ratio R of the geared transmission mechanism 5 is greater than the speed reducing ratio of the conventional planetary gear sets.

As described, given that the number of teeth z_{P1} of the first pinion 14 and the number of teeth z_{P2} of the second pinion 15 are set to the same number, the speed reduction ratio R of the geared transmission mechanism 5 may be increased by setting the number of teeth z_{R1} of the first ring gear 12 and the number of teeth z_{R2} of the second ring gear 13 to different numbers. In this case, the speed reduction ratio R of the geared transmission mechanism 5 is increased with a reduction in a difference between the number of teeth z_{R1} of the first ring gear 12 and the number of teeth z_{R2} of the second ring gear 13.

That is, the speed reduction ratio R of the geared transmission mechanism 5 is increased to the maximum value given that the difference between the number of teeth z_{R1} of the first ring gear 12 and the number of teeth z_{R2} of the second ring gear 13 is 1. For example, given that the number of teeth z_{P1} of the first pinion 14 is 17, the number of teeth z_{P2} of the second pinion 15 is 17, the number of teeth z_{R1} of the first ring gear 12 is 49, the number of teeth z_{R2} of the second ring gear 13 is 50, the speed reduction ratio R of the geared transmission mechanism 5 is increased to the maximum value (=50) as expressed by the following expression:

R=1/{1−(49/17)·(17/50)}=50.

Given that the difference between the number of teeth z_{R1} of the first ring gear 12 and the number of teeth z_{R2} of the second ring gear 13 is 0, the speed reduction ratio R of the geared transmission mechanism 5 reaches an infinite value in the abstract. In other words, if the first gear ratio u₁ of the fixed element and the second gear ratio u₂ of the output element are set to the same value, the speed reduction ratio R of the geared transmission mechanism 5 reaches an infinite value. In this case, since the first ring gear 12 is the fixed element, the second ring gear 13 integrated with the output member 3 is not allowed to rotate. In order to avoid such disadvantage, according to the exemplary embodiment of the present disclosure, the first gear ratio u₁ and the second gear ratio u₂ are set to different values. According to the exemplary embodiment of the present disclosure, therefore, the speed reduction ratio R of the geared transmission mechanism 5 can be increased without reaching the infinite value. In other words, the speed reduction ratio R of the geared transmission mechanism 5 is reduced with an increase in the difference between the first gear ratio u₁ and the second gear ratio u₂. That is, the speed reduction ratio R of the geared transmission mechanism 5 can be increased by reducing the difference between the first gear ratio u₁ and the second gear ratio u₂ to a value close to 0.

In addition, a sun gear is not arranged around the rotational center axis AL in the geared transmission mechanism 5 as a complex planetary gear unit. According to the exemplary embodiment of the present disclosure, therefore, the speed reducing unit 1 having the geared transmission mechanism 5 may be downsized.

Further, number of gears in the speed reducing unit 1 can be reduced. According to the first example shown in FIG. 1, in the geared transmission mechanism 5, four sets of the first pinion 14, the second pinion 15, and the pinion shaft 16 are arranged around the input member 2. Specifically, one first ring gear 12, one second ring gear 13, four first pinions 14, and four second pinions 15 are arranged in the geared transmission mechanism 5. That is, the total number of the gears employed in the geared transmission mechanism 5 is 10. On the other hand, total 20 gears are employed in the hub reduction gear unit shown in FIG. 2 of JP-A-2019-60480. Thus, only one-half of gears are required to form the geared transmission mechanism 5 according to the first example. Furthermore, although the same number of gears are employed as the drive unit described in JP-A-2005-308111, the speed reduction ratio R of the geared transmission mechanism 5 can be increased greater than that of the drive unit described in JP-A-2005-308111.

Thus, the speed reducing unit 1 according to the exemplary embodiment of the present disclosure has a simple structure, but the speed reduction ratio of the speed reducing unit 1 is greater than that of the conventional sped reducing units.

Here will be explained examples of using the speed reducing unit 1 shown in FIG. 1 as a hub mechanism in an automobile.

Turning to FIG. 2, there is shown the second example of the present disclosure in which the speed reducing unit 1 shown in FIG. 1 is employed as a hub mechanism (or hub bearing) in an on-board power unit 21 mounted on a vehicle Ve to generate a drive torque or a brake torque. The on-board power unit 21 comprises an actuator 22, an input gear 23, a differential unit 24, a driveshaft 25, and a hub bearing 26 as the speed reducing unit 1 shown in FIG. 1.

The actuator 22 generates a drive torque for propelling the vehicle Ve, or a brake torque or a regenerative torque for decelerating or stopping the vehicle Ve. To this end, for example, at least any one of an internal combustion engine, an electric motor, and a brake device may be adopted as the actuator 22. According to the second example shown in FIG. 2, the actuator 22 comprises an electric motor 22a, a brake device 22b, and a parking brake 22c.

Specifically, the electric motor 22a generates the drive torque by translating an electric energy to a rotational energy (i.e., a torque). The electric motor 22a also serves as a regenerative brake to apply the regenerative brake torque as a resistance to the vehicle Ve, when rotated passively by an external torque to generate electricity. For example, a permanent magnet type synchronous motor or an induction motor may be adopted as the electric motor 22a.

For example, an electromagnetic brake that generates a magnetic attraction force to stop a rotation of a predetermined rotary member when energized may be adopted as the brake device 22b. Instead, a conventional hydraulic brake may also be adopted as the brake device 22b. The parking brake 22c applies the brake force to the vehicle Ve when the vehicle Ve is parked.

The brake force established by the parking brake 22c may be maintained even after turning off a main switch of the vehicle Ve. To this end, for example, an electric brake that generates a frictional braking force using a feed screw mechanism driven by a motor may be adopted as the parking brake 22c. In the second example shown in FIG. 2, the brake device 22b and the parking brake 22c use a common output shaft (not shown) to deliver the brake torque to wheels (not shown).

The input gear 23 comprises an input gear shaft 23a that supports the input gear 23 and that rotates integrally with the input gear 23. The input gear 23 and the input gear shaft 23a are held in a case 27 of the on-board power unit 21 while being supported by the case 27 in a rotatable manner. Both ends of the input gear shaft 23a protrude from the case 27 respectively to be connected to the actuator 22. Specifically, one end (i.e., the right end in FIG. 1) of the input gear shaft 23a is joined to an output shaft (not shown) of the electric motor 22a, and the other end (i.e., the left end in FIG. 1) of the input gear shaft 23a is joined to the common output shaft of the brake device 22b and the parking brake 22c. The input gear 23 is meshed with a differential ring gear 24a of the differential unit 24.

The differential unit 24 as a conventional differential gear unit comprises the above-mentioned differential ring gear 24a and an output shaft 24b. As illustrated in FIG. 2, the differential unit 24 is held in the case 27 together with the input gear 23, and the output shaft 24b is supported by the case 27 in a rotatable manner. The differential ring gear 24a is meshed with the input gear 23 so that the torque of the actuator 22 is delivered to the differential ring gear 24a. Both ends of the output shaft 24b protrude respectively from both sides of the case 27 to be connected to driveshafts 25 so that the torque is transmitted between the differential unit 24 and each of the hub bearings 26 via the driveshafts 25. For example, a torque vectoring device described in JP-A-2019-160039 may be adopted as the differential unit 24.

The driveshafts 25 extends on both sides of the differential unit 24. Specifically, the right one of the driveshafts 25 in FIG. 2 is interposed between the output shaft 24b of the differential unit 24 and an input shaft 29 of the right one of the hub bearings 26 to transmit the torque therebetween. Likewise, the left one of the driveshafts 25 in FIG. 2 is interposed between the output shaft 24b of the differential unit 24 and an input shaft 29 of the left one of the hub bearings 26 to transmit the torque therebetween.

A wheel 32 is connected to a chassis 28 in a rotatable manner through the hub bearing 26. To this end, in the second example shown in FIG. 2, the input member 2 of the speed reducing unit 1 serves as an input shaft 29 of the hub bearing 26 to which an output torque of the actuator 22 is transmitted, and the output member 3 of the speed reducing unit 1 serves as an output hub 30 of the hub bearing 26 that delivers the torque to the wheel 32. The fixed member 4 of the speed reducing unit 1 is fixed to the chassis 28 to serve as a fixed hub 31 of the hub bearing 26.

Specifically, the input shaft 29 is connected to the output shaft 24b of the differential unit 24 through the driveshaft 25 so that the input shaft 29, the driveshaft 25, and the output shaft 24b are rotated integrally. The flange 3a of the output hub 30 is fixed to the wheel 32 by a bolt so that the output hub 30 and the wheel 32 are rotated integrally. That is, the output hub 30 serves as a wheel hub. The fixed hub 31 is fixed to the chassis 28 through e.g., a suspension mechanism (not shown). Specifically, the flange 4a of the fixed hub 31 is fixed to a flange 33 of the suspension mechanism by a bolt, and hence the fixed hub 31 is not allowed to rotate.

Thus, in the on-board power unit 21, the speed reducing unit 1 serves as the hub bearing 26 to transmit the torque of the actuator 22 to the wheel 32 through the driveshaft 25.

As described, the speed reducing unit 1 is diametrically downsized, therefore, the speed reducing unit 1 may be fitted easily into an inner circumferential space of the wheel 32. In addition, since the speed reduction ratio R of the geared transmission mechanism 5 is increased, the torque of the actuator 22 can be multiplied sufficiently. For this reason, the actuator 22 serving as a prime mover may also be downsized. As a result, a weight of the vehicle Ve may be trimmed, and a greater design freedom within the chassis 28 may be ensured.

Turning to FIG. 3, there is shown the third example of the present disclosure in which the speed reducing unit 1 shown in FIG. 1 is employed as a hub mechanism (or hub bearing) in an in-wheel power unit 41. The power unit 41 is arranged in an inner circumferential space of a wheel 43 of a wheel assembly 42 to generate at least one of a drive torque and a brake torque. According to the third example shown in FIG. 3, the power unit 41 comprises an actuator 44 and a hub bearing 45.

The actuator 44 generates a drive torque for propelling the vehicle Ve, or a brake torque or a regenerative torque for decelerating or stopping the vehicle Ve. To this end, for example, at least any one of an electric motor and a brake device may be adopted as the actuator 44. According to the third example, an electric motor 44a is adopted as the actuator 44.

Specifically, the electric motor 44a generates the drive torque by translating an electric energy to a rotational energy (i.e., a torque). The electric motor 44a also serves as a regenerative brake to apply the regenerative brake torque as a resistance to the vehicle Ve, when rotated passively by an external torque to generate electricity. For example, a permanent magnet type synchronous motor or an induction motor may be adopted as the electric motor 44a. Otherwise, the brake device 22b or the parking brake 22c may also be adopted as the actuator 44 instead of the electric motor 44a.

In the vehicle Ve, each wheel assembly 42 is connected to a chassis 46 in a rotatable manner through the hub bearing 45. In FIG. 3, however, only one of the wheel assemblies 42 is depicted for the sake of illustration.

In the third example, the input member 2 of the speed reducing unit 1 serves as an input shaft 47 of the hub bearing 45 to which an output torque of the actuator 44 is transmitted, and the output member 3 of the speed reducing unit 1 serves as an output hub 48 of the hub bearing 45 that delivers the torque to the wheel assembly 42. The fixed member 4 of the speed reducing unit 1 is fixed to the chassis 46 to serve as a fixed hub 49 of the hub bearing 45.

Specifically, the input shaft 47 is connected directly to the output shaft 44b of the electric motor 44a so that the input shaft 47 and the output shaft 44b are rotated integrally. The flange 3a of the output hub 48 is fixed to the wheel 43 by a bolt so that the output hub 48 and the wheel assembly 42 are rotated integrally. That is, the output hub 48 serves as a wheel hub. The fixed hub 49 is fixed to the actuator 44 through e.g., a suspension mechanism (not shown). Specifically, the flange 4a of the fixed hub 49 is fixed to a flange 44d formed on a housing 44c of the actuator 44 by a bolt, and hence the fixed hub 49 is not allowed to rotate. The actuator 44 to which the hub bearing 45 is fixed is connected to the chassis 46 through a suspension mechanism 50.

Thus, in the in-wheel power unit 41, the speed reducing unit 1 is held in the wheel 43 to serve as the hub bearing 45 to transmit the torque of the electric motor 44a as the actuator 44 to the wheel assembly 42.

As described, the speed reducing unit 1 is diametrically downsized, therefore, the speed reducing unit 1 may be fitted easily into an inner circumferential space of the wheel 43. In addition, since the speed reduction ratio R of the geared transmission mechanism 5 is increased, the torque of the actuator 44 can be multiplied sufficiently. For this reason, the actuator 44 serving as a prime mover may also be downsized. As a result, a greater design freedom in the wheel 43 may be ensured, and hence the electric motor 44a, the brake device 22b or the like may be arranged easily in the wheel 43.

Thus, the speed reducing unit 1 according to the exemplary embodiment of the present disclosure may be applied to the on-board power unit 21 and the in-wheel power unit 41. In the case of arranging the speed reducing unit 1 in the wheel 43 together with the downsized electric motor 44a, an unsprung weight of the vehicle can be reduced. Especially, in the case of employing the electric motor 22a or 44a and the brake device 22b as the actuator 22 or 44, the regenerative torque and the brake torque are delivered to a same point of a tire thorough the speed reducing unit 1. In this case, therefore, behavior of the vehicle can be stabilized when stopping the vehicle.

What is claimed is:

1. A speed reducing unit that transmits a torque between an input member and an output member while multiplying the torque, comprising:
a geared transmission mechanism that transmits a torque between the input member and the output member; and
a fixed member that supports the input member, the output member, and the geared transmission mechanism in a rotatable manner, and that fixes a fixed element of the geared transmission mechanism,
wherein the geared transmission mechanism comprises:
a first ring gear as an internal gear that is fixed to the fixed member;
a second ring gear as an internal gear that is attached to the output member coaxially with the first ring gear to be rotated integrally with the output member;
a first pinion meshing with the first ring gear;
a second pinion that is arranged coaxially with the first pinion to be rotated integrally with the first pinion while meshing with the second ring gear;
a pinion shaft that supports the first pinion and the second pinion in a rotatable manner; and
a carrier that supports the first pinion and the second pinion in a rotatable manner through the pinion shaft, and that is mounted on the input member to be rotated integrally with the input member, and
a gear ratio between the first ring gear and the first pinion and a gear ratio between the second ring gear and the second pinion are set to different values such that a rotational speed of the output member is reduced lower than a rotational speed of the input member.

2. The speed reducing unit as claimed in claim 1,
wherein number of teeth of the first ring gear and number of teeth of the second ring gear are set to different numbers, and
number of teeth of the first pinion and number of teeth of the second pinion are set to the same number.

3. The speed reducing unit as claimed in claim 1,
wherein number of teeth of the first ring gear and number of teeth of the second ring gear are set to the same number, and
number of teeth of the first pinion and number of teeth of the second pinion are set to different numbers.

4. The speed reducing unit as claimed in claim 1,
wherein number of teeth of the first ring gear and number of teeth of the second ring gear are set to different numbers, and
number of teeth of the first pinion and number of teeth of the second pinion are set to different numbers.

5. The speed reducing unit as claimed in claim 1,
wherein the input member includes an input shaft to which an output torque of an actuator of a vehicle is applied,
the output member includes an output hub that is attached to a wheel of the vehicle to be rotated integrally with the wheel,
the fixed member includes a fixed hub that is fixed to a chassis of the vehicle or a housing of the actuator, and
the speed reducing unit serves as a hub mechanism that connects the wheel to the chassis.

6. The speed reducing unit as claimed in claim 5,
wherein the fixed hub is connected to the chassis, and
the actuator is disposed on the chassis to deliver the output torque to the input shaft through a driveshaft.

7. The speed reducing unit as claimed in claim 5,
wherein the fixed hub is fixed to the housing while being connected to the chassis together with the actuator, and
the actuator is held in an inner circumferential space of the wheel to apply the output torque directly to the input shaft.

8. The speed reducing unit as claimed in claim 5, wherein the actuator includes at least any one of:
an engine that generates a drive torque;
an electric motor that generates a drive torque and a regenerative torque; and
a brake device that generates a brake torque.
